(19) United States
(12) Patent Application Publication
(10) Pub. No.: US 2005/0144257 A1
(43) Pub. Date: Jun. 30, 2005

(54) Method and system of manipulating XML data in support of data mining

(76) Inventors: Roberto J. Bayardo, Morgan Hill, CA (US); Laurent Chavet, Kirkland, WA (US); Daniel F. Gruhl, San Jose, CA (US); Pradhan G. Pattanayak, San Jose, CA (US)

Correspondence Address: LEONARD T. GUZMAN;IBM CORPORATION, INTELLECTUAL PROPERTY LAW, DEPT. C4TA/J2B, 650 HARRY ROAD, SAN JOSE, CA, 95120-6099, US

(21) Appl. No.: 10/734,345

(22) Filed: Dec. 13, 2003

(51) Int. Cl. G06F 15/16; G06F 17/21; G06F 17/24

(52) U.S. Cl. 709/218; 715/513

(57) ABSTRACT

The present invention provides a method and system of manipulating XML data in support of data mining. In an exemplary embodiment, the method and system include (1) storing the XML data in a network format to a buffer, thereby resulting in a stored network representation of the XML data and (2) selecting at least one feature of the XML data via a naive selection operating on the stored network representation of the XML data. In an exemplary embodiment, the method and system include (1) storing the XML data in a network format to a buffer, thereby resulting in a stored network representation of the XML data and (2) modifying at least one feature of the XML data via a naive modification operating on the stored network representation of the XML data. In an exemplary embodiment, the network format includes xtalk format.

### RELATED APPLICATIONS

The present application is related to pending and commonly-assigned U.S. patent application Ser. No. 09/757,046, filed Jan. 8, 2001. The contents of U.S. patent application Ser. No. 09/757,046 are hereby incorporated by reference.

### FIELD OF THE INVENTION

The present invention relates to data encoding, data extraction, and data transformation, and particularly relates to a method and system of manipulating XML data in support of data mining.

### BACKGROUND OF THE INVENTION

With data-mining algorithms continuing to improve in performance and scalability, the performance bottleneck of knowledge discovery has shifted from the mining and analysis phase to the data extraction and transformation phase. In particular, several performance issues in extracting and transforming market basket data when it is represented in Extensible Markup Language (hereinafter XML) format exist.

XML

XML is becoming an increasingly common format for data representation in data mining domains due to its expressiveness, flexibility, and cross-platform nature. Formats are emerging to represent everything from data mining processes, the models they create, and the data to be mined. For example, the traditional market basket has a prior art XML representation 100 as shown in FIG. 1A. In the case of web data, the “basket” might have a prior art XML representation 110 as shown in FIG. 1B.

XML representations 100 and 110 are natural representations for many domains (e.g. a market basket) where the records consist of one or more set-valued features or attributes (e.g., items purchased), or where the data is in some sense “schema-less”, unknown in advance, or likely to change. XML representation 110 may be stored in an XML database.

Problems

Despite its convenience, the XML data-format presents several performance and scalability challenges, often making XML processing the primary performance bottleneck in the data-mining process. This problem becomes particularly acute in the case of very large market baskets with hundreds or even thousands of items in each market basket, such as data-sets that arise from the SemTag (Please see S. Dill, N. Eiron, D. Gibson, D. Gruhl, A. Jhingran, T. Kanugo, K. S. McCurley, S. Rajagopalan, A. Tomkins, J. A. Tomlin, and J. Y. Zien, Seeker: An Architecture for web-scale text analytics, Proceedings of the World Wide Web 2003 Conference, 2003.) system, which performs automated semantic tagging of the entire World Wide Web. An exemplary SemTag data-set has an average of roughly 300 items per basket, or XML representation, and almost a quarter billion baskets total.

Selection

A typical operation performed on such an XML representation 110 (once the features of interest are identified) is to select a portion of the entire XML representation (i.e. features of interest). Selecting a portion of the entire XML representation includes (1) scanning through the entire XML representation (e.g. parsing the XML representation) and (2) extracting only a subset of the most relevant items, features of interest. This produces a simple, but very time sensitive inner loop. For example, in exemplary XML representation 110, if features URL 112, COMPANY 114, and PERSON 116 were of interest, prior art XML parsing techniques, such as DOM or SAX, would scan the entire XML representation 110 in order to select only the handful of features including URL 112, COMPANY 114, and PERSON 116. This scanning is equivalent to the prior art XPath (Please see J. Clark and S. DeRose, Xml path language (xpath) version 1.0, http://www.w3.org/T/xpath.) query 120 in FIG. 1C, with query terms URL 122, COMPANY 124, and PERSON 126 corresponding to features URL 112, COMPANY 114, and PERSON 116 that are of interest. Handling such a query 120 using standard XML processing tools, such as DOM or SAX, would involve full parsing and validation of XML representation 110. This step is compute intensive.

In addition, modification is an extremely common operation in SemTag, as new or improved taggers (i.e. routines which examine existing data and add zero or more new tags as a result) are constantly being developed which need to run against the entire corpus. Since the modification operation includes parsing, modification of XML representations, such as XML representation 110, is also very compute intensive.

xtalk

xtalk, a prior art technique for the network serialization of XML data is described in (1) pending and commonly-assigned U.S. patent application Ser. No. 09/757,046, filed Jan. 8, 2001, and (2) R. Agrawal, R. Bayardo, D. Gruhl, and S. Papadimitriou, Vinci: A service-oriented architecture for rapid development of web applications, Proceedings of the Tenth International World Wide Web Conference (WWW2001), Hong Kong, China, 2001, p. 355-365. Parsing network XML data encoded in xtalk format is considerably faster than parsing traditional XML data via DOM or SAX.

An xtalk representation of XML representation 110 is depicted as prior art xtalk representation 130 in FIG. 1D, formatted for readability, where the numbers are network order 4 byte unsigned longs, with xtalk fragment 132 corresponding to URL feature 112. A compact xtalk representation of XML representation 110 is depicted as prior art xtalk representation 140 in FIG. 1E, with (1) xtalk fragment 142 corresponding to xtalk fragment 132 that corresponds to URL feature 112 and (2) xtalk fragment 141 corresponding to xtalk fragment 131. For each feature, xtalk encodes the string length of the feature in an xtalk fragment corresponding to the feature, as shown in FIGS. 1D and 1E.

Web Speed

Thus, prior art approaches for XML data manipulation, such as DOM and SAX, are mostly inadequate for high performance data mining of web-scale (i.e. massive) data-sets at web speed, where web speed is the ability to process 10 billion documents in less than one day. Thus, a 128 node cluster of share nothing parallel miners operating at web speed would be able to process about 904.2 documents per second. Thus, any system that can support comfortably more than 1000 documents per second can be said to be running at web speed.

Therefore, a method and system of manipulating XML data in support of data mining is needed.

### SUMMARY OF THE INVENTION

The present invention provides a method and system of manipulating XML data in support of data mining. In an exemplary embodiment, the method and system include (1) storing the XML data in a network format to a buffer, thereby resulting in a stored network representation of the XML data and (2) selecting at least one feature of the XML data via a naive selection operating on the stored network representation of the XML data.

In an exemplary embodiment, the network format includes xtalk format. In an exemplary embodiment, the storing includes writing the XML data in xtalk format to the buffer, thereby resulting in a stored xtalk representation of the XML data, where the xtalk representation includes xtalk fragments corresponding to fragments of the XML data, where one of the xtalk fragments includes header information of the XML data, and where each of the remaining xtalk fragments corresponds uniquely with a feature of the XML data. In a particular embodiment, the writing includes saving each of the xtalk fragments to a corresponding block of the buffer. In a particular embodiment, the saving includes, for each xtalk fragment corresponding to a feature of the XML data, reserving the string length of the feature in the corresponding block of the buffer of the xtalk fragment.

In an exemplary embodiment, the selecting includes (a) identifying the corresponding block of the buffer that saved the xtalk fragment that corresponds to the at least one feature of the XML data, (b) packing the identified corresponding block of the buffer to the front of the buffer via an XML packing process, and (c) updating the corresponding block of the buffer that saved the xtalk fragment that corresponds to the header information of the XML data. In a particular embodiment, the XML packing process includes at least one call to memmove. In a particular embodiment, the updating includes reflecting a reduction in the number of features stored in the buffer.

In a further embodiment, the method and system include modifying at least one feature of the XML data via a naive modification operating on the stored network representation of the XML data. In a particular embodiment, the method and system include modifying at least one feature of the XML data via a naive modification operating on the stored xtalk representation of the XML data.

In an exemplary embodiment, the method and system include (1) storing the XML data in a network format to a buffer, thereby resulting in a stored network representation of the XML data and (2) modifying at least one feature of the XML data via a naive modification operating on the stored network representation of the XML data. In an exemplary embodiment, the network format includes xtalk format.

In an exemplary embodiment, the storing includes writing the XML data in xtalk format to the buffer, thereby resulting in a stored xtalk representation of the XML data, where the xtalk representation includes xtalk fragments corresponding to fragments of the XML data, where one of the xtalk fragments includes header information of the XML data, and where each of the remaining xtalk fragments corresponds uniquely with a feature of the XML data. In a particular embodiment, the writing includes saving each of the xtalk fragments to a corresponding block of the buffer. In a particular embodiment, the saving includes, for each xtalk fragment corresponding to a feature of the XML data, reserving the string length of the feature in the corresponding block of the buffer of the xtalk fragment.

In an exemplary embodiment, the modifying includes (a) identifying the corresponding block of the buffer that saved the xtalk fragment that corresponds to the at least one feature of the XML data, (b) packing the identified corresponding block of the buffer to the front of the buffer via an XML packing process, (c) updating the corresponding block of the buffer that saved the xtalk fragment that corresponds to the header information of the XML data, (d) storing a new xtalk fragment that corresponds to a new feature of the XML data in a block of unoccupied buffer, thereby resulting in a new block of buffer, (e) appending the new block of buffer to the buffer, and (f) revising the corresponding block of the buffer that saved the xtalk fragment that corresponds to the header information of the XML data. In a particular embodiment, the XML packing process includes at least one call to memmove. In a particular embodiment, the updating includes reflecting the number of features stored in the buffer.

In a further embodiment, the method and system include selecting at least one feature of the XML data via a naive selection operating on the stored network representation of the XML data. In a particular embodiment, the method and system include selecting at least one feature of the XML data via a naive selection operating on the stored xtalk representation of the XML data.

The present invention also provides a method and system of manipulating XML data in support of data mining at web speed, where the XML data is stored in an XML representation of the XML data. In an exemplary embodiment, the method and system include selecting at least one feature of the XML data via a naive selection operating on the XML representation of the XML data.

In an exemplary embodiment, the selecting includes performing an in-place selection of the at least one feature. In a particular embodiment, the performing includes (1) scanning the XML representation for the at least one feature and (2) editing a buffer storing the XML representation in place via an XML packing process. In a particular embodiment, the performing includes scanning the XML representation for the at least one feature. In a particular embodiment, the performing includes editing a buffer storing the XML representation in place via an XML packing process. In a particular embodiment, the XML packing process includes at least one call to memmove. In a particular embodiment, the XML representation of the XML data includes a stored database representation of the XML data.

In a further embodiment, the method and system include modifying at least one feature of the XML data via a naive modification operating on the XML representation of the XML data. In a particular embodiment, the XML representation of the XML data includes a stored database representation of the XML data.

In an exemplary embodiment, the method and system include modifying at least one feature of the XML data via a naive modification operating on the XML representation of the XML data. In an exemplary embodiment, the modifying includes (1) selecting the at least one feature via an in-place selection of the at least one feature, (2) removing the selected feature from the XML representation, thereby resulting in a modified XML representation, and (3) adding at least one new feature with a new value to the modified XML representation.

In a particular embodiment, the adding includes appending the at least one new feature to the modified XML representation. In a particular embodiment, the appending includes (a) parsing backward from the end one close tag of the modified XML representation and (b) inserting the at least one new feature to the modified XML representation before the end one close tag. In a particular embodiment, the XML representation of the XML data includes a stored database representation of the XML data.

In a further embodiment, the method and system include selecting at least one feature in the XML data via a naive selection operating on the XML representation of the XML data. In a particular embodiment, the XML representation of the XML data includes a stored database representation of the XML data.

In an exemplary embodiment, the method and system include storing the XML data in a network format to a buffer, thereby resulting in a stored network representation of the XML data. In an exemplary embodiment, the network format includes xtalk format.

In an exemplary embodiment, the storing includes writing the XML data in xtalk format to the buffer, thereby resulting in a stored xtalk representation of the XML data, where the xtalk representation includes xtalk fragments corresponding to fragments of the XML data, where one of the xtalk fragments includes header information of the XML data, and where each of the remaining xtalk fragments corresponds uniquely with a feature of the XML data. In a particular embodiment, the writing includes saving each of the xtalk fragments to a corresponding block of the buffer. In a particular embodiment, the saving includes, for each xtalk fragment corresponding to a feature of the XML data, reserving the string length of the feature in the corresponding block of the buffer of the xtalk fragment.

The present invention provides a computer program product usable with a programmable computer having readable program code embodied therein of manipulating XML data in support of data mining. In an exemplary embodiment, the computer program product includes (1) computer readable code for storing the XML data in a network format to a buffer, thereby resulting in a stored network representation of the XML data and (2) computer readable code for selecting at least one feature of the XML data via a naive selection operating on the stored network representation of the XML data.

### THE FIGURES

FIG. 1A is a block diagram of a prior art XML representation of a traditional market basket.

FIG. 1B is a block diagram of a prior art XML representation of web data.

FIG. 1C is a diagram of a prior art XPath query.

FIG. 1D is a block diagram of a prior art xtalk representation of an XML representation.

FIG. 1E is a block diagram of a prior art compact xtalk representation of an XML representation.

FIG. 2A is a block diagram of the execution of the present invention in accordance with an exemplary embodiment of the present invention.

FIG. 2B is a flowchart in accordance with an exemplary embodiment of the present invention.

FIG. 2C is a flowchart of the storing step in accordance with an exemplary embodiment of the present invention.

FIG. 2D is a flowchart of the writing step in accordance with a particular embodiment of the present invention.

FIG. 3A is a block diagram of the execution of the present invention in accordance with an exemplary embodiment of the present invention.

FIG. 3B is a block diagram of the execution of the present invention in accordance with an exemplary embodiment of the present invention.

FIG. 3C is a flowchart in accordance with an exemplary embodiment of the present invention.

FIG. 3D is a flowchart of the selecting step in accordance with a particular embodiment of the present invention.

FIG. 3E is a flowchart in accordance with a further embodiment of the present invention.

FIG. 4A is a block diagram of the execution of the present invention in accordance with an exemplary embodiment of the present invention.

FIG. 4B is a block diagram of the execution of the present invention in accordance with an exemplary embodiment of the present invention.

FIG. 4C is a flowchart in accordance with an exemplary embodiment of the present invention.

FIG. 4D is a flowchart of the modifying step in accordance with an exemplary embodiment of the present invention.

FIG. 4E is a flowchart in accordance with a further embodiment of the present invention.

FIG. 5A is a flowchart in accordance with an exemplary embodiment of the present invention.

FIG. 5B is a flowchart of the selecting step in accordance with an exemplary embodiment of the present invention.

FIG. 5C is a flowchart of the performing step in accordance with a particular embodiment of the present invention.

FIG. 5D is a flowchart in accordance with a further embodiment of the present invention.

FIG. 6A is a flowchart in accordance with an exemplary embodiment of the present invention.

FIG. 6B is a flowchart of the adding step in accordance with a particular embodiment of the present invention.

FIG. 6C is a flowchart of the appending step in accordance with a particular embodiment of the present invention.

FIG. 6D is a flowchart in accordance with a further embodiment of the present invention.

### DETAILED DESCRIPTION OF THE INVENTION

The present invention provides a method and system of manipulating XML data in support of data mining. The present invention allows for the selection of features of interest in an XML document of interest without having to perform a full parse of the XML document. In an exemplary embodiment, the method and system include (1) storing the XML data in a network format to a buffer, thereby resulting in a stored network representation of the XML data and (2) selecting at least one feature of the XML data via a naive selection operating on the stored network representation of the XML data. In an exemplary embodiment, the method and system include (1) storing the XML data in a network format to a buffer, thereby resulting in a stored network representation of the XML data and (2) modifying at least one feature of the XML data via a naive modification operating on the stored network representation of the XML data.

The present invention also provides a method and system of manipulating XML data in support of data mining at web speed, where the XML data is stored in an XML representation of the XML data. In an exemplary embodiment, the method and system include selecting at least one feature in the XML data via a naive selection operating on the XML representation of the XML data. In an exemplary embodiment, the method and system include modifying at least one feature of the XML data via a naive modification operating on the XML representation of the XML data.

In an exemplary embodiment, the method and system include storing the XML data in a network format to a buffer, thereby resulting in a stored network representation of the XML data.

Storing XML Data in a Network Format

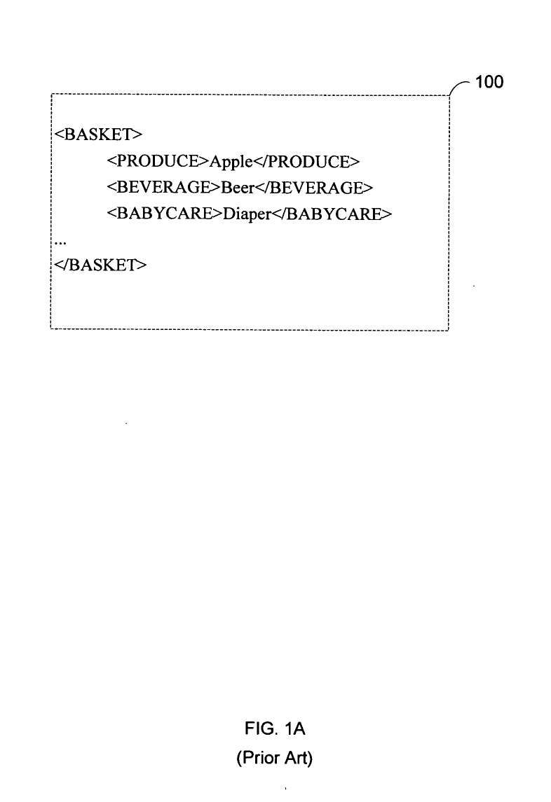

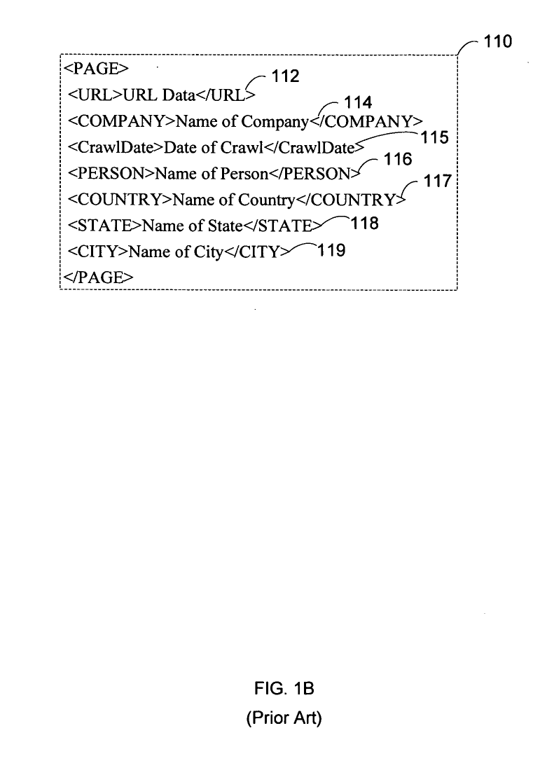

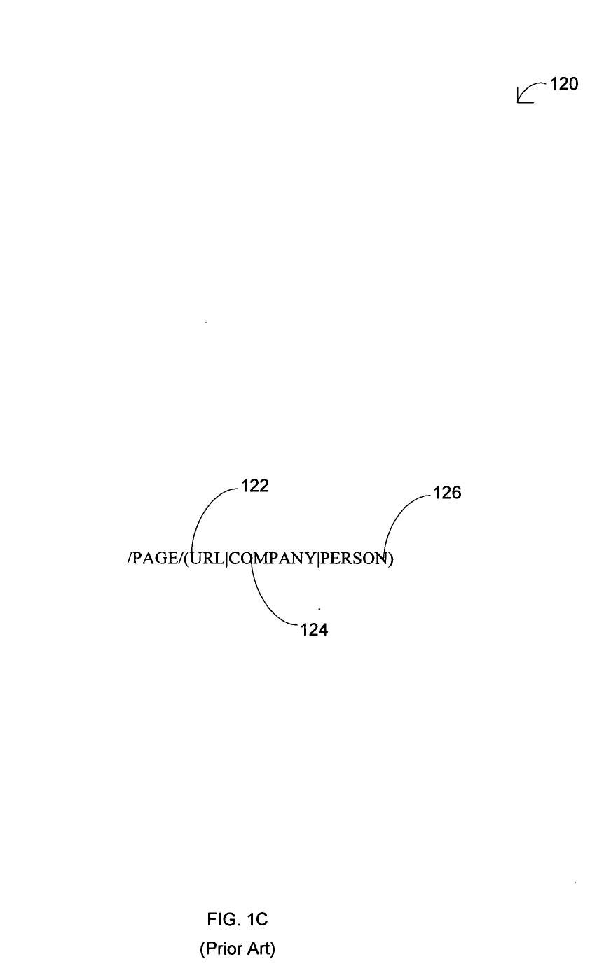

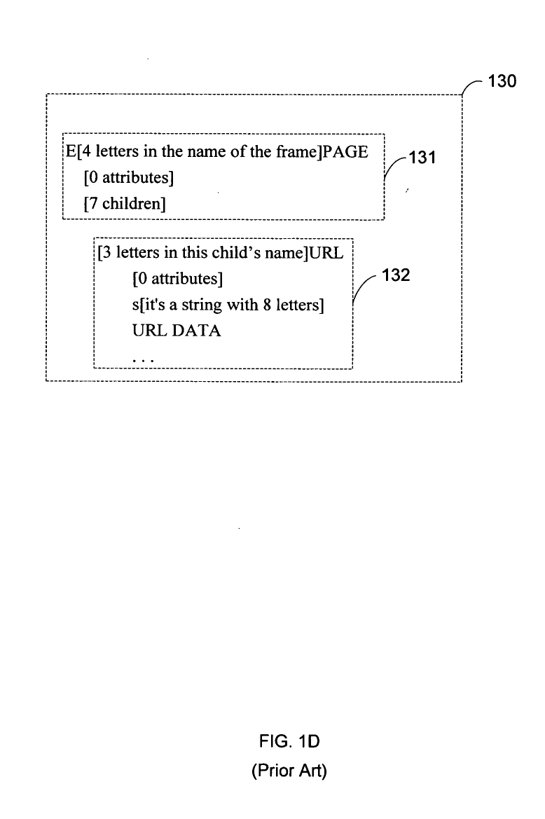

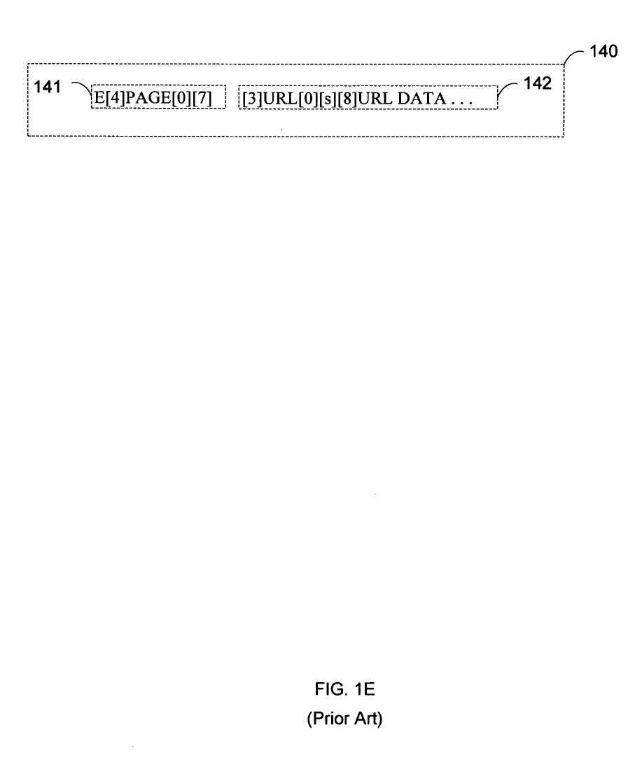

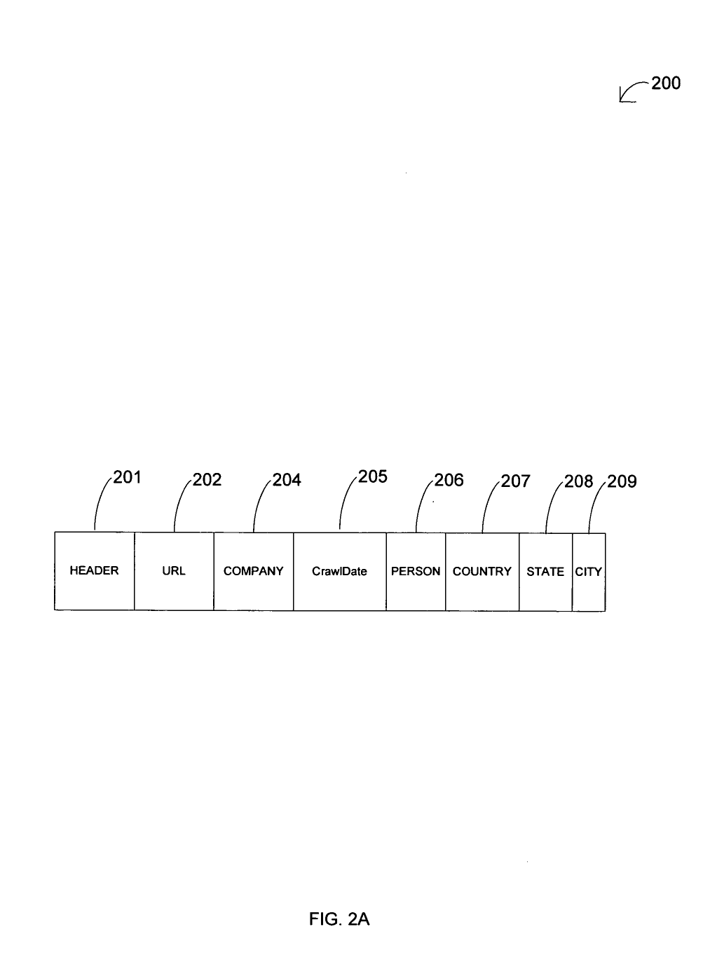

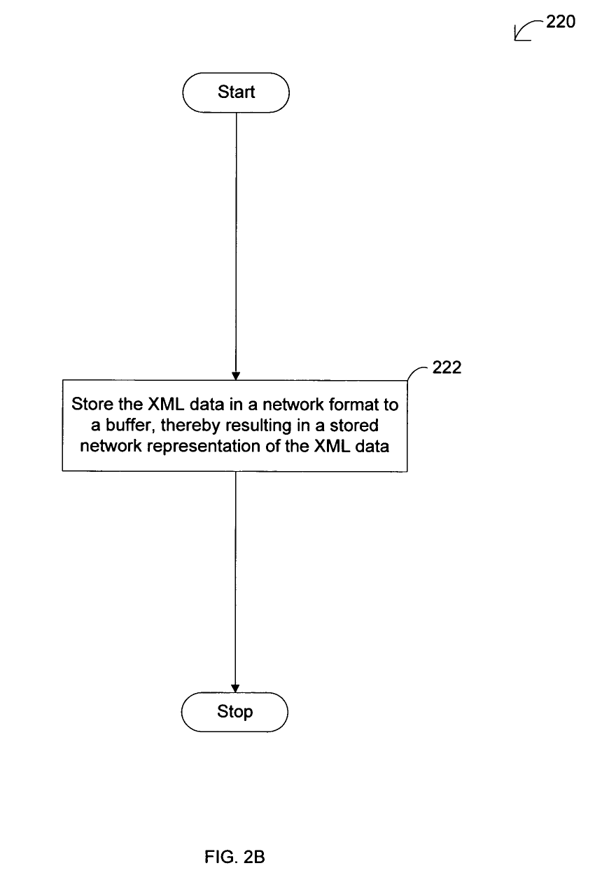

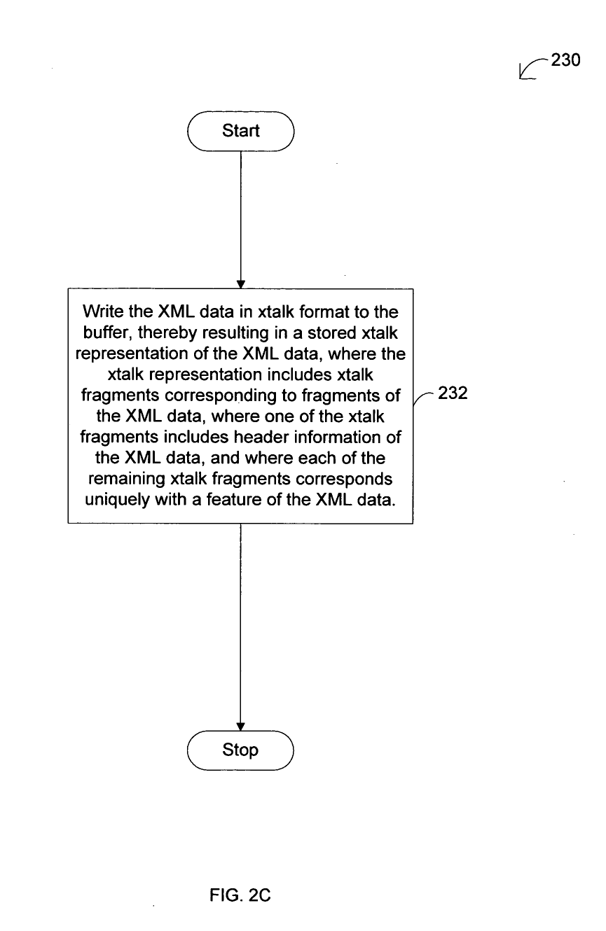

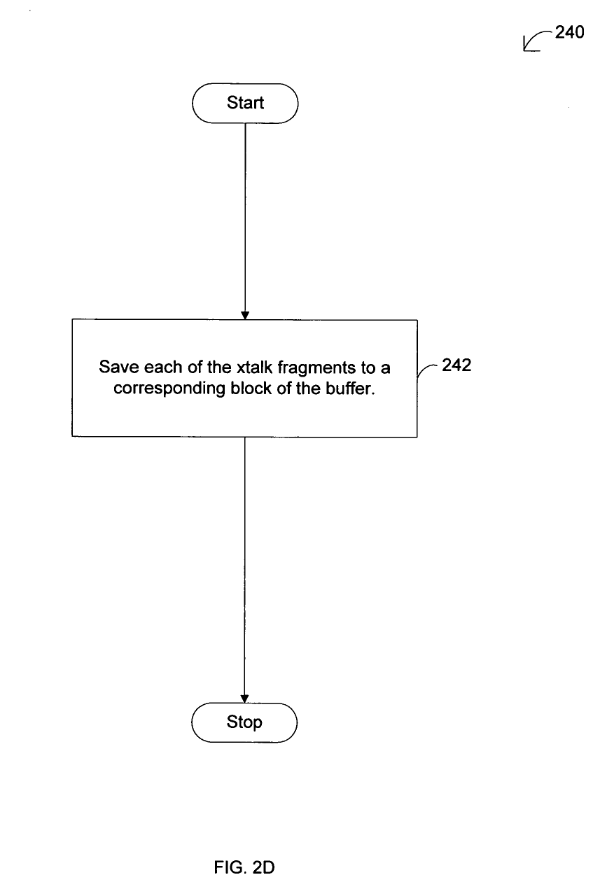

In an exemplary embodiment, the present invention includes storing XML data in a network format to a buffer. In a particular embodiment, the network format includes xtalk. Thus, in an exemplary embodiment, the present invention includes storing XML data, such as XML representation 110, in xtalk format, such as xtalk representation 140, to a buffer 200, as depicted in FIG. 2A, with blocks of buffer in buffer 200 storing xtalk fragments from xtalk representation 140. For example, header block 201 stores at least xtalk fragment 141 in FIG. 1E, while URL block 202 stores xtalk fragment 142 in FIG. 1E, where xtalk fragment 142 corresponds to URL feature 112 in FIG. 1B. Also, for example, COMPANY block 204 and PERSON block 206 store xtalk fragments that correspond COMPANY feature 114 and PERSON feature 116, respectively. In an exemplary embodiment, buffer 200 is a computer readable and writable disc. In an exemplary embodiment, buffer 200 is a computer readable and writable memory.

In a particular embodiment, for each feature in an XML representation 110, the present invention stores the string length of the feature in the block of buffer storing the xtalk fragment that corresponds to the feature, as shown in FIGS. 2A and 1E. In an exemplary embodiment, the present invention explicitly stores the structure of XML representation 110 in a compact form by storing xtalk representation 140 into buffer 200.

Referring to FIG. 2B, in an exemplary embodiment, the present invention includes a step 222 of storing the XML data in a network format to a buffer, thereby resulting in a stored network representation of the XML data. Referring to FIG. 2C, in an exemplary embodiment, storing step 222 includes a step 232 of writing the XML data in xtalk format to the buffer, thereby resulting in a stored xtalk representation of the XML data, where the xtalk representation includes xtalk fragments corresponding to fragments of the XML data, where one of the xtalk fragments includes header information of the XML data, and where each of the remaining xtalk fragments corresponds uniquely with a feature of the XML data. In a particular embodiment, as shown in FIG. 2D, writing step 232 includes a step 242 of saving each of the xtalk fragments to a corresponding block of the buffer.

Naïve Selection

In an exemplary embodiment, the present invention includes selecting features, such as features URL 112, COMPANY 114, and PERSON 116, of XML data via a naive selection method and system (tailored to the flat nature of market-basket data) operating on XML and xtalk representations of the XML data, such as XML representation 110 and xtalk representation 140, respectively.

Naïve XML Selection

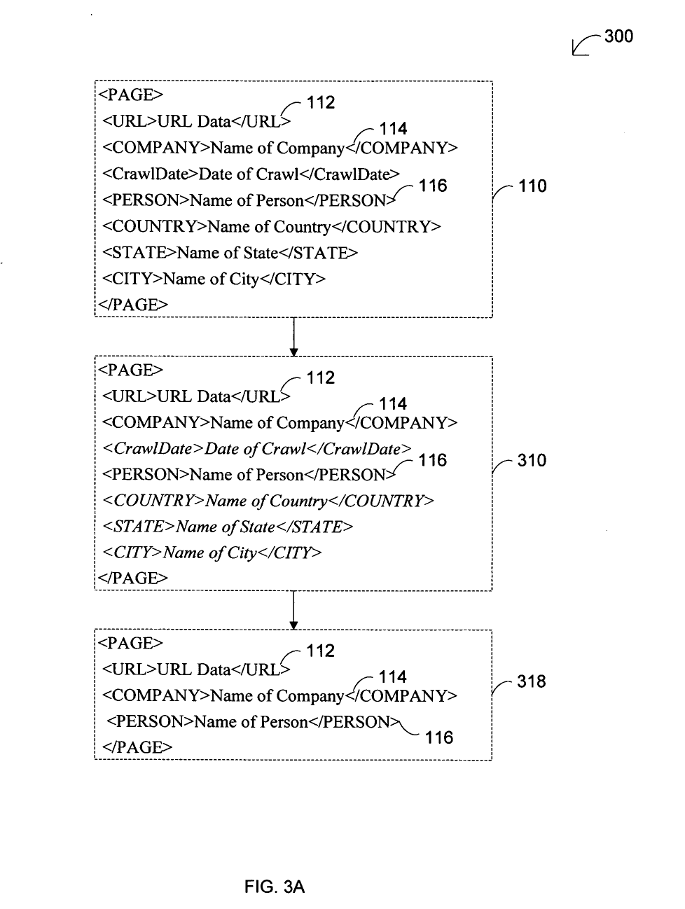

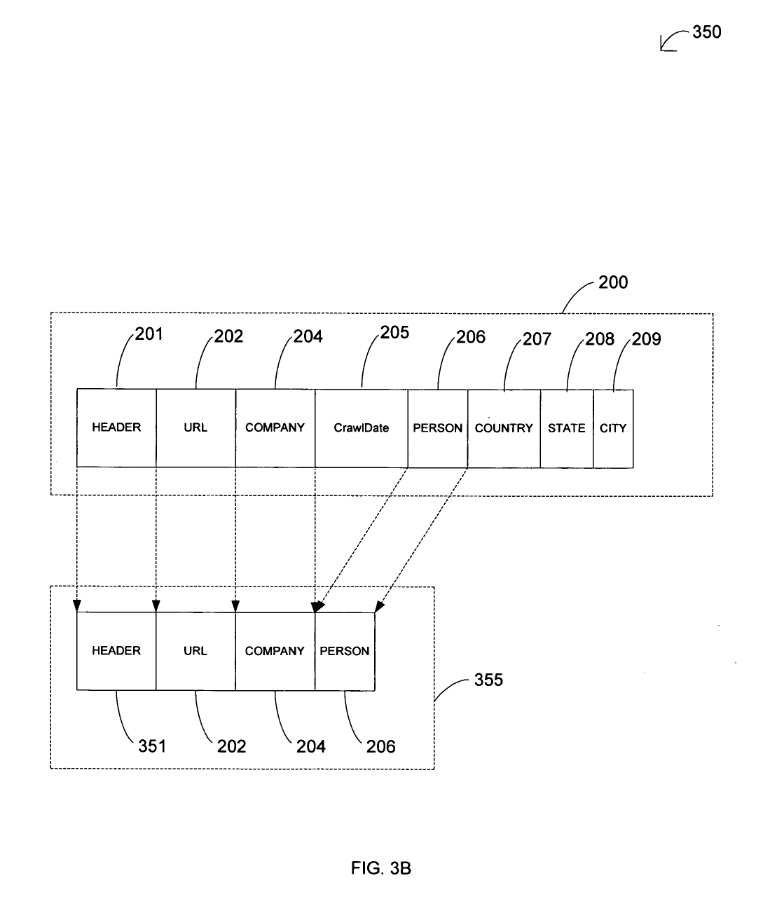

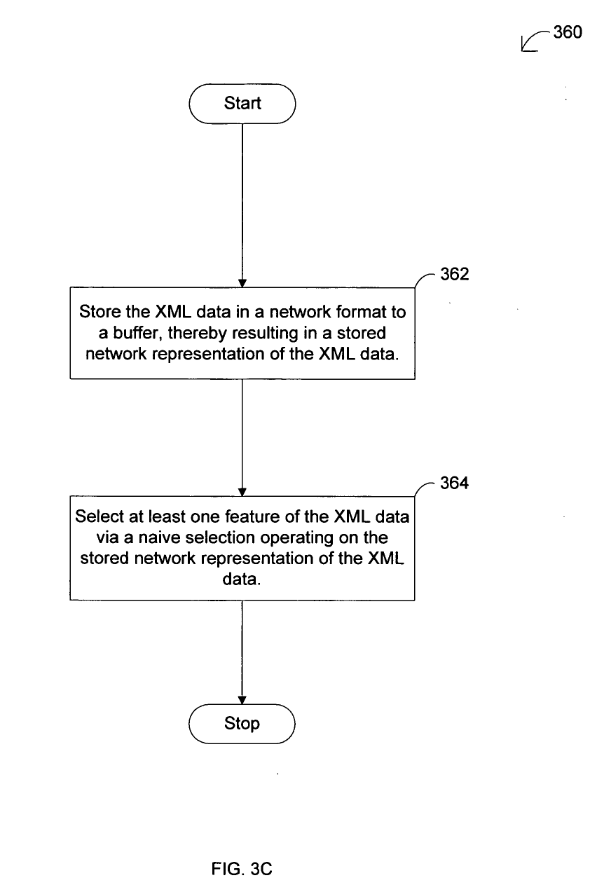

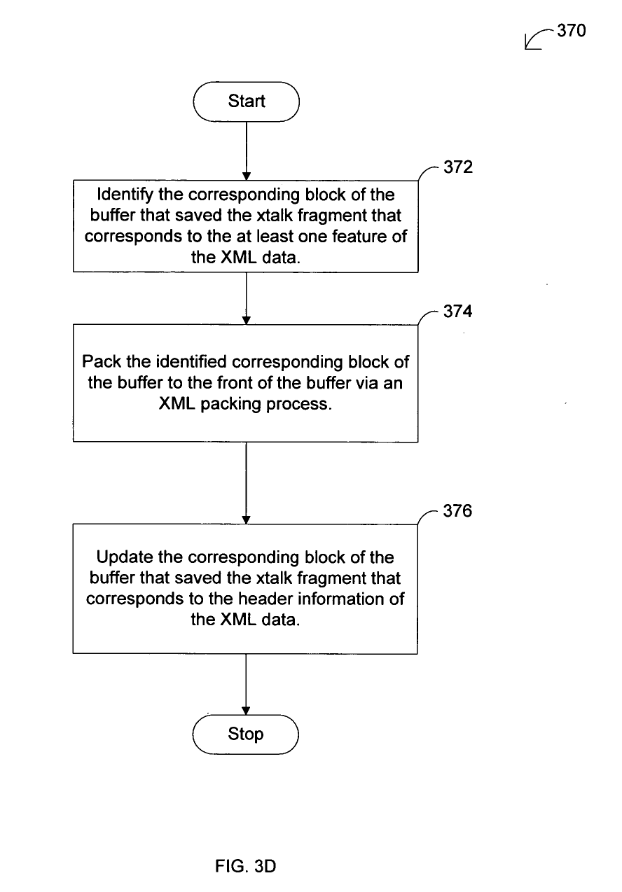

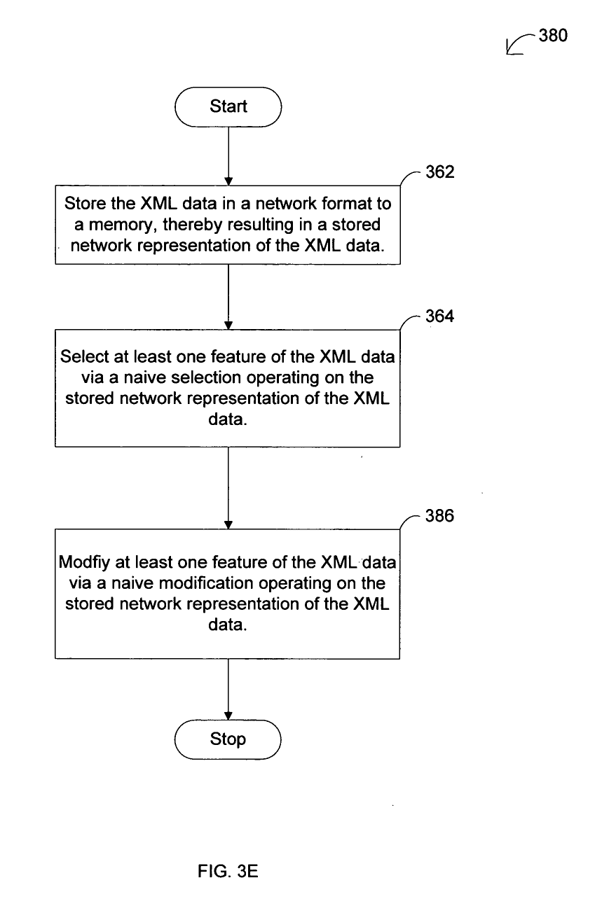

The present invention also provides a method and system of manipulating XML data in support of data mining at web speed, where the XML data is stored in an XML representation of the XML data. In an exemplary embodiment, as shown in FIG. 3A, the naive selection method and system includes selecting features, such as features URL 112, COMPANY 114, and PERSON 116, of XML data via a naïve XML selection 300 operating on an XML representation of the XML data, such as XML representation 110. In an exemplary embodiment, XML representation 110 is an XML database. In an exemplary embodiment, naïve XML selection 300 selects a portion of XML representation 110 without performing a full parse of the document by making a few simplifying assumptions, such as the following:
(1) the depth of one item XML representation is one;
(2) nesting of identical tags (e.g. <COMPANY> . . . </COMPANY> is a tag) is not allowed;
(3) embedding tags in comments is not allowed; and
(4) embedding tags in c:data is not allowed. For example, as shown in FIG. 3A, naïve XML selection 300 selects from XML representation 110 features URL 112, COMPANY 114, and PERSON 116 by performing an in-place selection of features URL 112, COMPANY 114, and PERSON 116, resulting in intermediate XML representation 310 and ultimately in final XML representation 318.

In an exemplary embodiment, naïve XML selection 300 includes (1) keeping track of (a) key names, (b) extents (where an extent comprise the text between an open and matching close tag (e.g. the text between <COMPANY> and </COMPANY> in <COMPANY> . . . </COMPANY>)), and (c) the current depth of XML representation 110 and (2) packing matching extents to the front of a buffer storing XML representation 110 via an XML packing process. In an exemplary embodiment, the XML packing process includes at one call to memmove. memmove is part of libc (Please see a libc implementation at http://www.gnu.org/software/libc/lobc.html.). In an exemplary embodiment, naïve XML selection 300 includes (1) scanning XML representation 110 for features of interest (i.e. requested tags), such as features URL 112, COMPANY 114, and PERSON 116, and (2) then, editing the buffer storing XML representation 110 in place via an XML packing process, such as memmove.

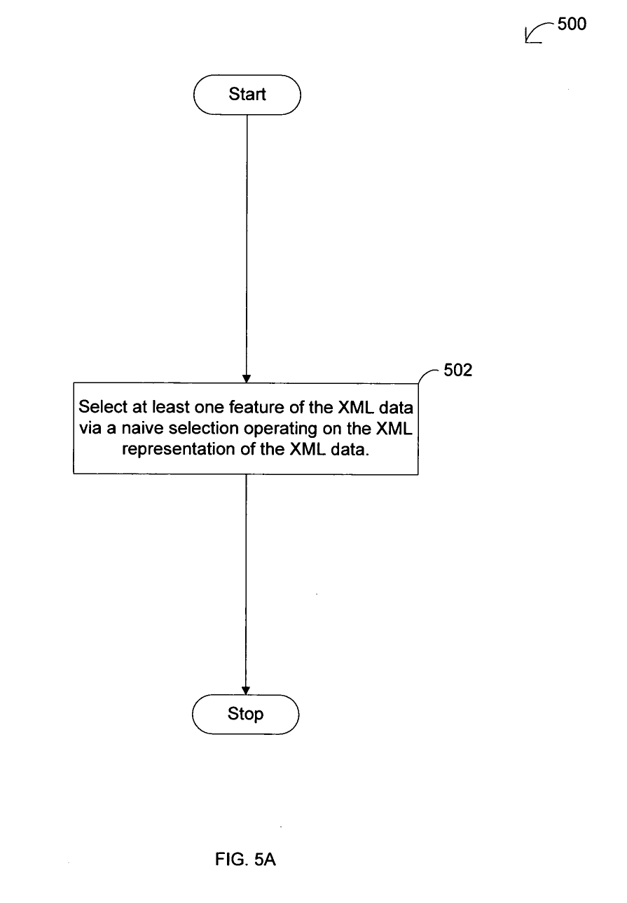

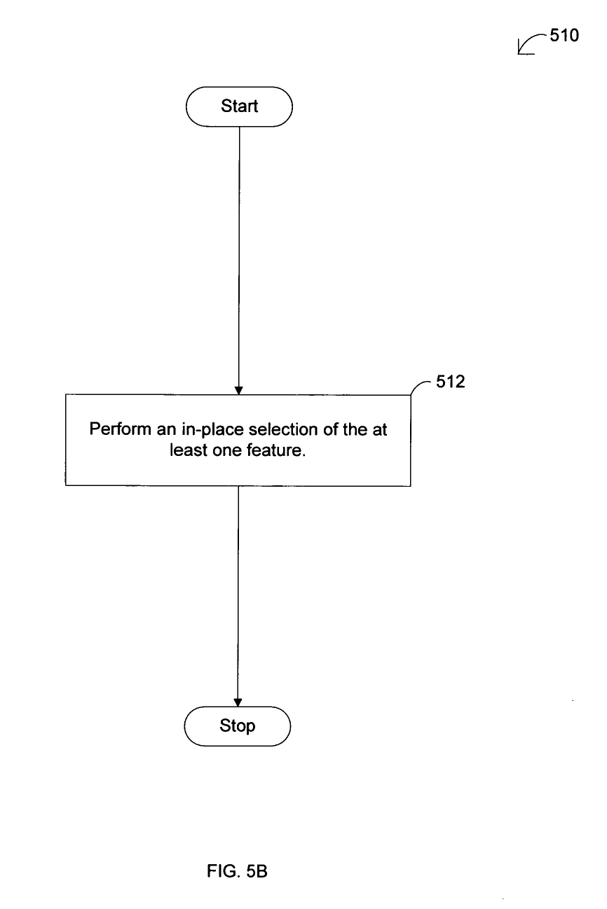

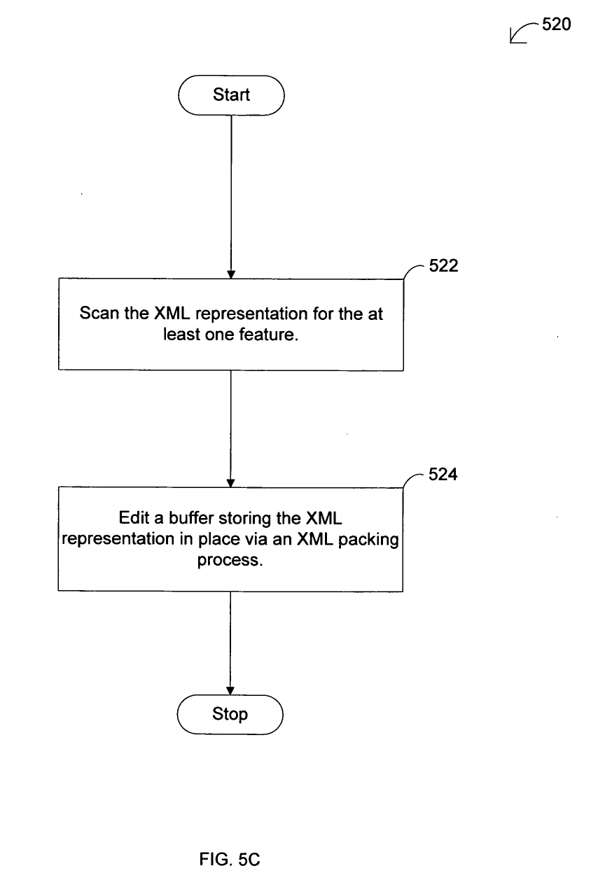

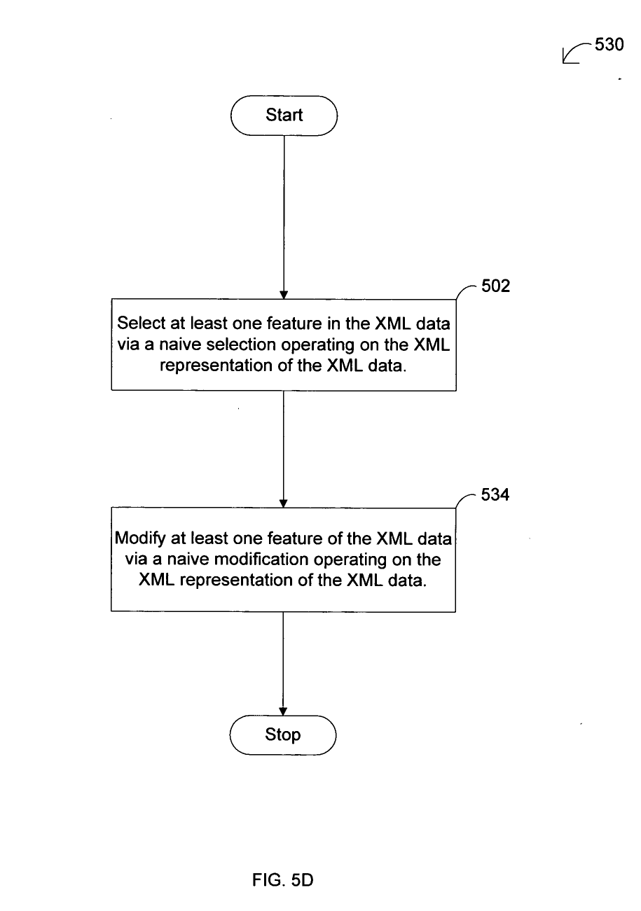

Referring to FIG. 5A, in an exemplary embodiment, the present invention includes a step 502 of selecting at least one feature in the XML data via a naive selection operating on the XML representation of the XML data. Referring to FIG. 5B, in an exemplary embodiment, selecting step 502 includes a step 512 of performing an in-place selection of the at least one feature. In a particular embodiment, as shown in FIG. 5C, performing step 512 includes a step 522 of scanning the XML representation for the at least one feature and a step 524 of editing a buffer storing the XML representation in place via an XML packing process. In an exemplary embodiment, performing step 512 includes a step of scanning the XML representation for the at least one feature. In an exemplary embodiment, performing step 512 includes a step of editing a buffer storing the XML representation in place via an XML packing process.

In a further embodiment, as shown in FIG. 5D, the present invention includes a step 534 of modifying at least one feature of the XML data via a naive modification operating on the XML representation of the XML data.

Naïve xtalk Selection

In an exemplary embodiment, as shown in FIG. 3B, the naive selection method and system includes selecting features, such as features URL 112, COMPANY 114, and PERSON 116, of XML data via a naïve xtalk selection 350 operating on an xtalk representation of the XML data, such as xtalk representation 140, stored in buffer 200. In an exemplary embodiment, naïve xtalk selection 350 selects from xtalk representation 140 features URL 112, COMPANY 114, and PERSON 116 by selecting URL block 202, COMPANY block 204, and PERSON block 206, respectively.

In an exemplary embodiment, naïve xtalk selection 350 includes (1) identifying blocks of buffer 200, such as URL block 202, COMPANY block 204, and PERSON block 206, storing xtalk fragments corresponding to features of interest (e.g. requested keys), such as URL feature 112, COMPANY features 114, and PERSON features 116, (2) packing the identified blocks of buffer to the front of buffer 200 via an XML packing process, thereby resulting in packed buffer 355, and (3) updating header block 201 to reflect the packing, thereby resulting in updated header block 351. In an exemplary embodiment, the XML packing process includes at least one call to memmove. In an exemplary embodiment, updating header block 201 includes reflecting a reduction in the number of “children”, or features, stored in buffer 200.

Since the string lengths are encoded for each feature in its corresponding xtalk fragment, naïve xtalk selection 350 does not need to keep track of where open and close tags, such as <URL> and </URL>, respectively, are located.

Referring to FIG. 3C, in an exemplary embodiment, the present invention includes a step 362 of storing the XML data in a network format to a buffer, thereby resulting in a stored network representation of the XML data and a step 364 of selecting at least one feature of the XML data via a naive selection operating on the stored network representation of the XML data. In an exemplary embodiment, storing step 362 includes storing step 222. Referring to FIG. 3D, in an exemplary embodiment, selecting step 364 includes a step 372 of identifying the corresponding block of the buffer that saved the xtalk fragment that corresponds to the at least one feature of the XML data, a step 374 of packing the identified corresponding block of the buffer to the front of the buffer via an XML packing process, and a step 376 of updating the corresponding block of the buffer that saved the xtalk fragment that corresponds to the header information of the XML data.

In a further embodiment, as shown in FIG. 3E, the present invention includes a step 386 of modifying at least one feature of the XML data via a naive modification operating on the stored network representation of the XML data.

Naïve Modification

In an exemplary embodiment, the present invention includes modifying features, or attributes, of XML data via a naive modification method and system (tailored to the flat nature of market-basket data) operating on XML and xtalk representations of the XML data, such as XML representation 110 and xtalk representation 140, respectively.

Naïve XML Modification

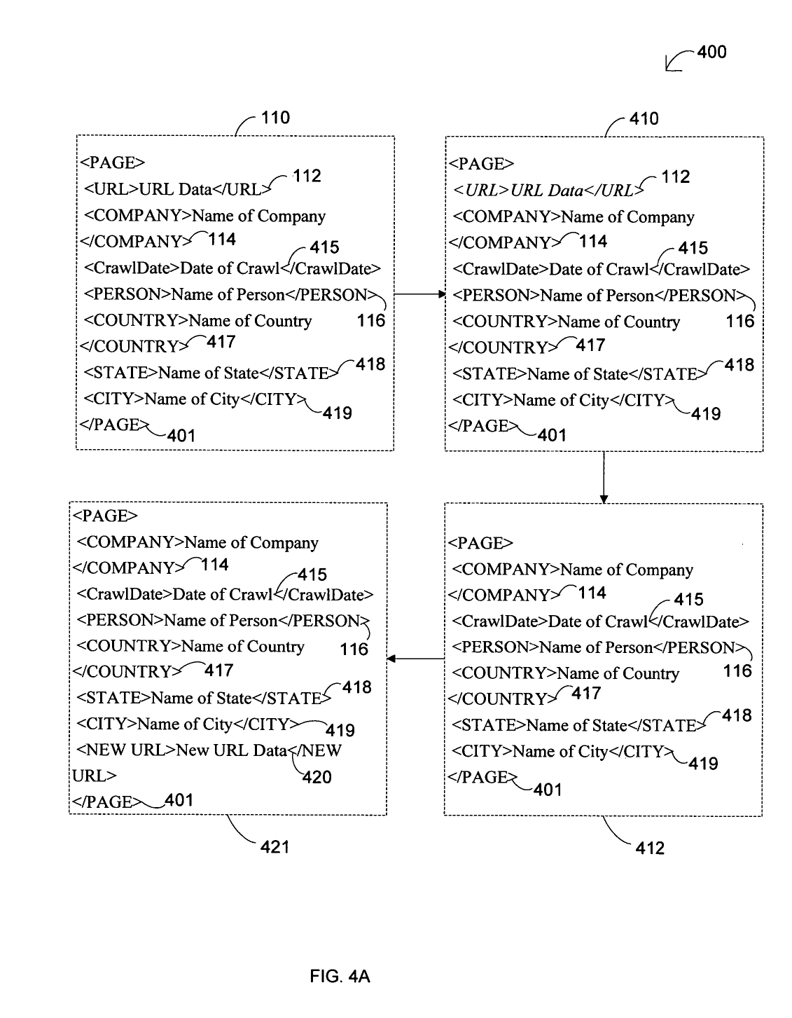

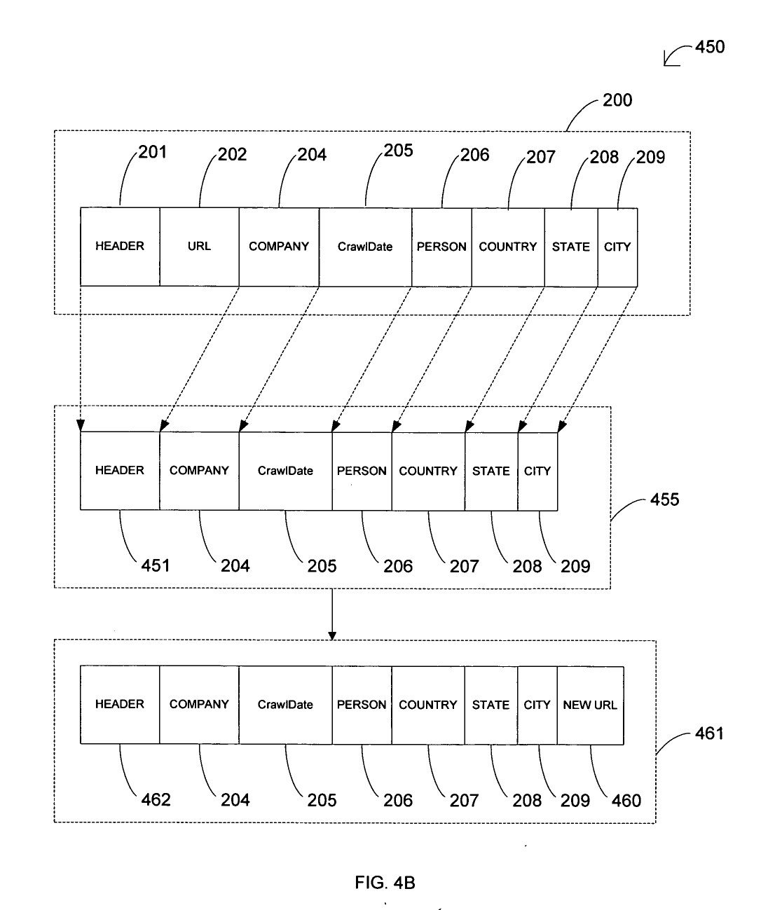

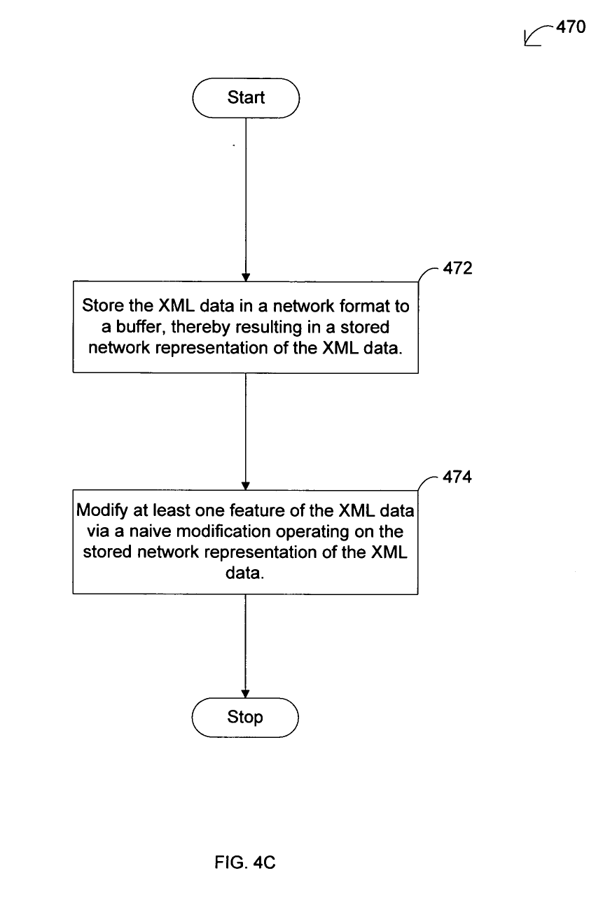

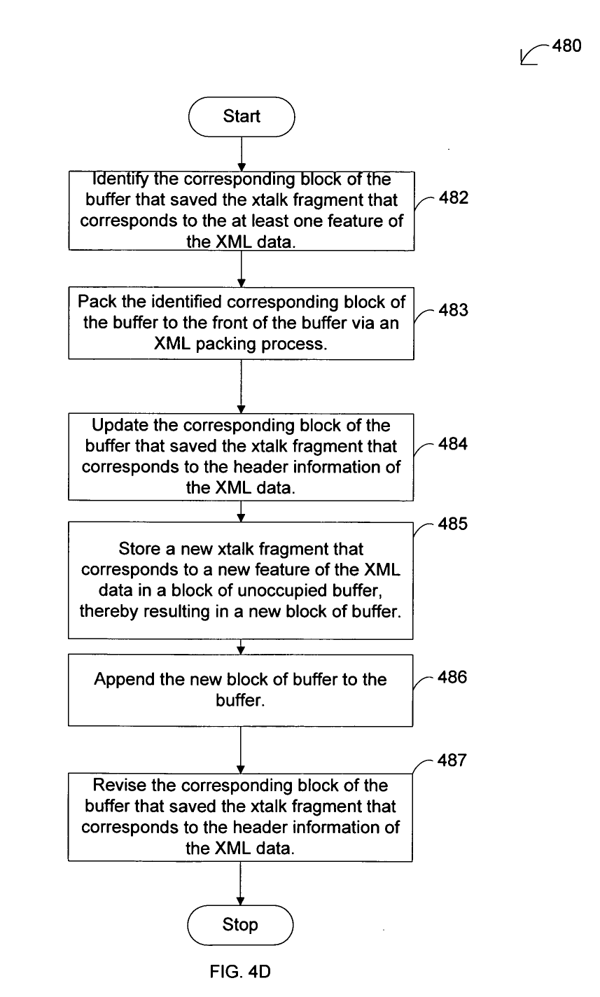

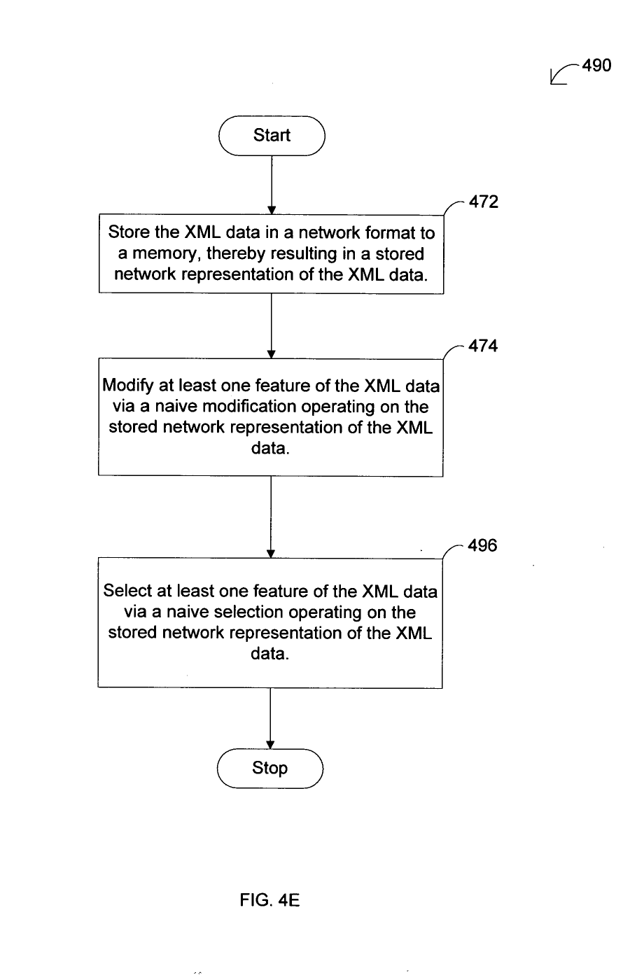

The present invention also provides a method and system of manipulating XML data in support of data mining at web speed, where the XML data is stored in an XML representation of the XML data. In an exemplary embodiment, as shown in FIG. 4A, the naive modification method and system includes modifying features, such as feature URL 112, of XML data via a naïve XML modification 400 operating on an XML representation of the XML data, such as XML representation 110. In an exemplary embodiment, XML representation 110 is an XML database. For example, as shown in FIG. 4A, naïve XML modification 400 selects from XML representation 110 feature URL 112 by performing an in-place selection of feature URL 112, resulting in intermediate XML representation 410, removes feature URL 112, resulting in XML representation 412, and adds new feature NEW URL 420 with a new value, NEW URL DATA, resulting in final XML representation 421.

In an exemplary embodiment, naïve XML modification 400 includes (1) removing an old value for a feature, such as removing feature URL 112 that had old value URL DATA, and (2) adding the new value for the feature, such as by adding new feature NEW URL 420 with new value NEW URL DATA. In an exemplary embodiment, adding a new feature, such as new feature NEW URL 420, includes appending the new feature to the XML representation, such as appending new feature NEW URL 420 to XML representation 412, thereby resulting in final XML representation 421. In an exemplary embodiment, appending a new feature includes parsing backward from the end one close tag, such as end one close tag 401, and inserting the new feature, such as new feature NEW URL 420, to XML representation 412 before the end one close tag, thereby resulting in final XML representation 421.

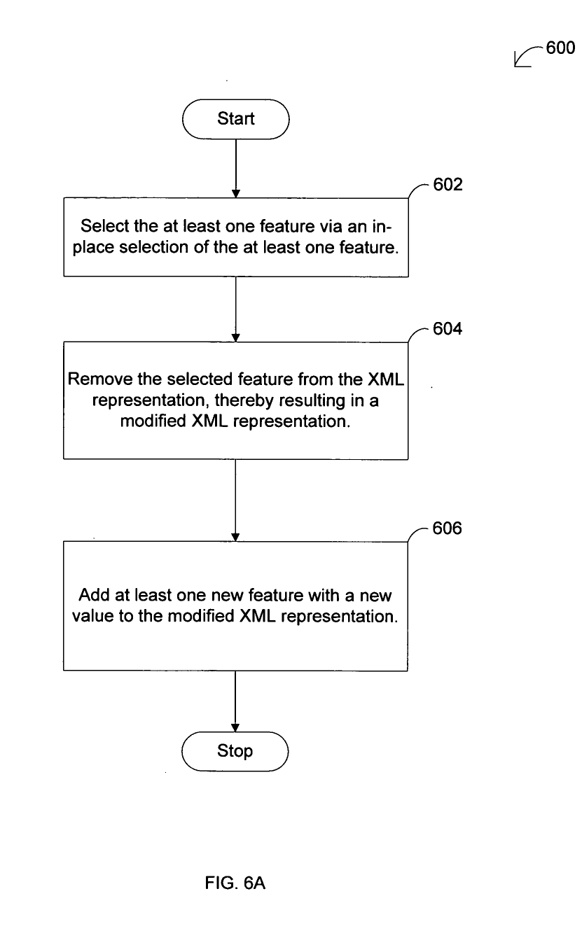

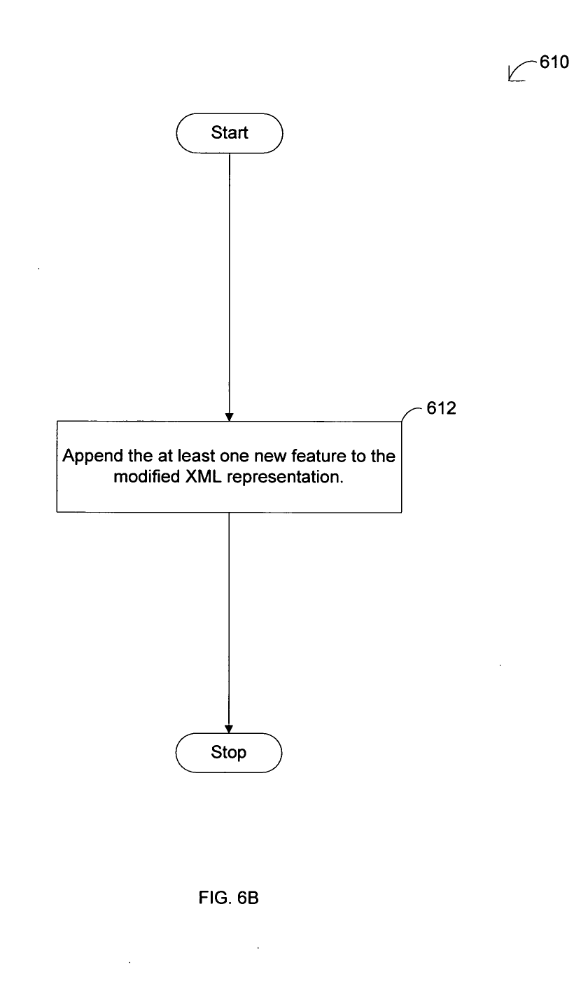

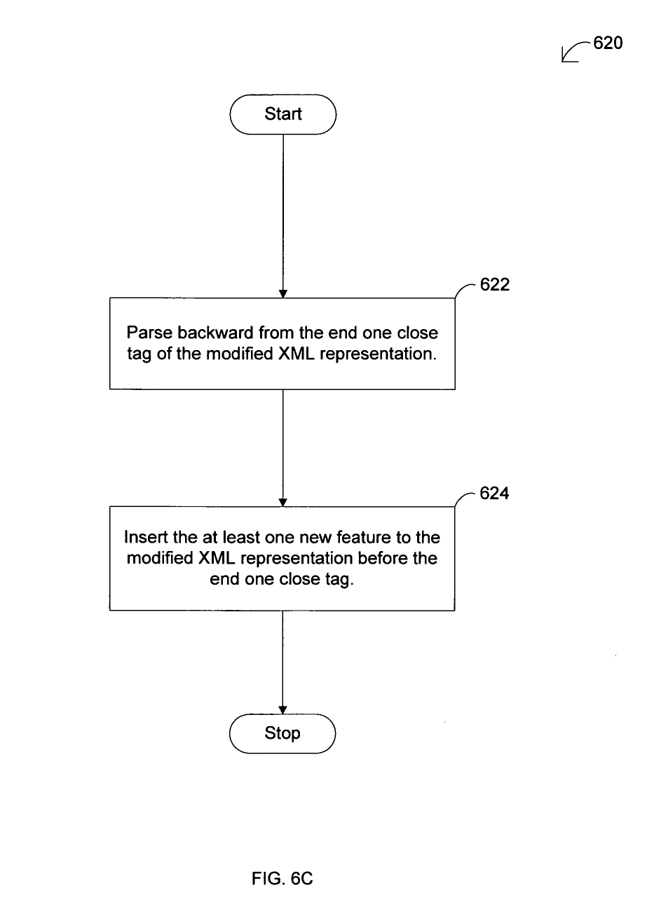

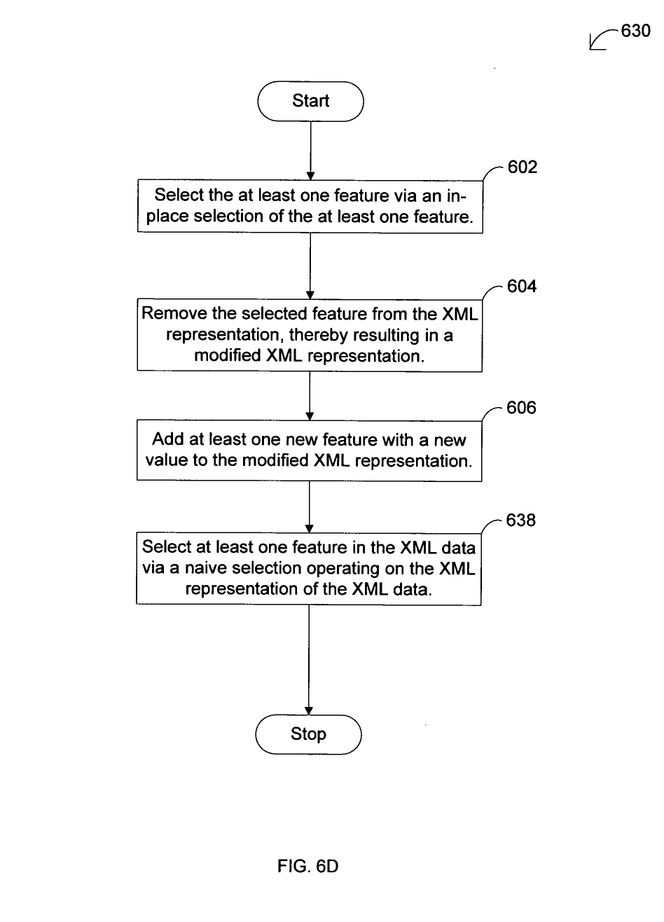

Referring to FIG. 6A, in an exemplary embodiment, the present invention includes a step 602 of selecting the at least one feature via an in-place selection of the at least one feature, a step 604 of removing the selected feature from the XML representation, thereby resulting in a modified XML representation, and a step 606 of adding at least one new feature with a new value to the modified XML representation. In a particular embodiment, as shown in FIG. 6B, adding step 606 includes a step 612 of appending the at least one new feature to the modified XML representation. In a particular embodiment, as shown in FIG. 6C, appending step 612 includes a step 622 of parsing backward from the end one close tag of the modified XML representation and a step 624 of inserting the at least one new feature to the modified XML representation before the end one close tag.

In a further embodiment, as shown in FIG. 6D, the method and system include a step 638 of selecting at least one feature in the XML data via a naive selection operating on the XML representation of the XML data.

Naïve xtalk Modification

In an exemplary embodiment, as shown in FIG. 4B, the naive modification method and system includes modifying features, such as feature URL 112, of XML data via a naïve xtalk modification 450 operating on an xtalk representation of the XML data, such as xtalk representation 140, stored in buffer 200. In an exemplary embodiment, naïve xtalk selection 450 (1) selects from xtalk representation 140 all features, such as features COMPANY 114, CrawlDate 115, PERSON 116, COUNTRY 117, STATE 118, and CITY 119, other than the feature to be modified, such as feature URL 112, by selecting blocks of buffer corresponding to those features, such as URL block 202, COMPANY block 204, and CrawlDate block 205, PERSON block 206, COUNTRY block 207, STATE block 208, and CITY block 209, respectively, and (2) appends a new block of buffer, 460 corresponding to a new feature 420 to the end of buffer 200.

In an exemplary embodiment, naïve xtalk modification 450 includes (1) identifying blocks of buffer 200, such as URL block 202, COMPANY block 204, and CrawlDate block 205, PERSON block 206, COUNTRY block 207, STATE block 208, and CITY block 209, storing xtalk fragments corresponding to features of interest (e.g. requested keys), such as features COMPANY 114, CrawlDate 115, PERSON 116, COUNTRY 117, STATE 118, and CITY 119, (2) packing the identified blocks of buffer to the front of buffer 200 via an XML packing process, thereby resulting in packed buffer 455, (3) updating header block 201 to reflect the packing, thereby resulting in updated header block 451, (4) appending a block of unoccupied buffer, such a NEW URL block 460, that stores an xtalk fragment that corresponds to a new feature 420 to packed buffer 455, thereby resulting in final buffer 461, and (5) updating updated header block 451 to reflect the appending, thereby resulting in final header block 462.

In an exemplary embodiment, the XML packing process includes at least one call to memmove. In an exemplary embodiment, updating header block 201 includes reflecting the number of “children”, or features, stored in buffer 200.

Referring to FIG. 4C, in an exemplary embodiment, the present invention includes a step 472 of storing the XML data in a network format to a buffer, thereby resulting in a stored network representation of the XML data and a step 474 of modifying at least one feature of the XML data via a naive modification operating on the stored network representation of the XML data. In an exemplary embodiment, storing step 472 includes storing step 222. Referring to FIG. 4D, in an exemplary embodiment, modifying step 474 includes a step 482 of identifying the corresponding block of the buffer that saved the xtalk fragment that corresponds to the at least one feature of the XML data, a step 483 of packing the identified corresponding block of the buffer to the front of the buffer via an XML packing process, a step 484 of updating the corresponding block of the buffer that saved the xtalk fragment that corresponds to the header information of the XML data, a step 485 of storing a new xtalk fragment that corresponds to a new feature of the XML data in a block of unoccupied buffer, thereby resulting in a new block of buffer, a step 486 of appending the new block of buffer to the buffer, and a step 487 of revising the corresponding block of the buffer that saved the xtalk fragment that corresponds to the header information of the XML data.

In a further embodiment, as shown in FIG. 4E, the present invention includes a step 496 of selecting at least one feature of the XML data via a naive selection operating on the stored network representation of the XML data.

### Conclusion

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

1. A method of manipulating XML data in support of data mining, the method comprising:
storing the XML data in a network format to a buffer, thereby resulting in a stored network representation of the XML data; and
selecting at least one feature of the XML data via a naive selection operating on the stored network representation of the XML data.

2. The method of claim 1 wherein the network format comprises xtalk format.

3. The method of claim 2 wherein the storing comprises:
writing the XML data in xtalk format to the buffer, thereby resulting in a stored xtalk representation of the XML data, wherein the xtalk representation comprises xtalk fragments corresponding to fragments of the XML data,
wherein one of the xtalk fragments comprises header information of the XML data and
wherein each of the remaining xtalk fragments corresponds uniquely with a feature of the XML data.

4. The method of claim 3 wherein the writing comprises:
saving each of the xtalk fragments to a corresponding block of the buffer.

5. The method of claim 4 wherein the saving comprises:
for each xtalk fragment corresponding to a feature of the XML data, reserving the string length of the feature in the corresponding block of the buffer of the xtalk fragment.

6. The method of claim 4 wherein the selecting comprises:
identifying the corresponding block of the buffer that saved the xtalk fragment that corresponds to the at least one feature of the XML data;
packing the identified corresponding block of the buffer to the front of the buffer via an XML packing process; and
updating the corresponding block of the buffer that saved the xtalk fragment that corresponds to the header information of the XML data.

7. The method of claim 6 wherein the XML packing process comprises at least one call to memmove.

8. The method of claim 6 wherein the updating comprises:
reflecting a reduction in the number of features stored in the buffer.

9. The method of claim 1 further comprising modifying at least one feature of the XML data via a naive modification operating on the stored network representation of the XML data.

10. The method of claim 8 further comprising modifying at least one feature of the XML data via a naive modification operating on the stored xtalk representation of the XML data.

11. A method of manipulating XML data in support of data mining, the method comprising:
storing the XML data in a network format to a buffer, thereby resulting in a stored network representation of the XML data; and
modifying at least one feature of the XML data via a naive modification operating on the stored network representation of the XML data.

12. The method of claim 11 wherein the network format comprises xtalk format.

13. The method of claim 12 wherein the storing comprises:
writing the XML data in xtalk format to the buffer, thereby resulting in a stored xtalk representation of the XML data, wherein the xtalk representation comprises xtalk fragments corresponding to fragments of the XML data,
wherein one of the xtalk fragments comprises header information of the XML data and
wherein each of the remaining xtalk fragments corresponds uniquely with a feature of the XML data.

14. The method of claim 13 wherein the writing comprises:
saving each of the xtalk fragments to a corresponding block of the buffer.

15. The method of claim 14 wherein the saving comprises:
for each xtalk fragment corresponding to a feature of the XML data, reserving the string length of the feature in the corresponding block of the buffer of the xtalk fragment.

16. The method of claim 14 wherein the modifying comprises:
identifying the corresponding block of the buffer that saved the xtalk fragment that corresponds to the at least one feature of the XML data;
packing the identified corresponding block of the buffer to the front of the buffer via an XML packing process;
updating the corresponding block of the buffer that saved the xtalk fragment that corresponds to the header information of the XML data;
storing a new xtalk fragment that corresponds to a new feature of the XML data in a block of unoccupied buffer, thereby resulting in a new block of buffer;
appending the new block of buffer to the buffer; and
revising the corresponding block of the buffer that saved the xtalk fragment that corresponds to the header information of the XML data.

17. The method of claim 16 wherein the XML packing process comprises at least one call to memmove.

18. The method of claim 16 wherein the updating comprises:
reflecting the number of features stored in the buffer.

19. The method of claim 11 further comprising selecting at least one feature of the XML data via a naive selection operating on the stored network representation of the XML data.

20. The method of claim 18 further comprising selecting at least one feature of the XML data via a naive selection operating on the stored xtalk representation of the XML data.

21. A method of manipulating XML data in support of data mining, wherein the XML data is stored in an XML representation of the XML data, the method comprising:
selecting at least one feature of the XML data via a naive selection operating on the XML representation of the XML data.

22. The method of claim 21 wherein the selecting comprises:
performing an in-place selection of the at least one feature.

23. The method of claim 22 wherein the performing comprises:
scanning the XML representation for the at least one feature; and
editing a buffer storing the XML representation in place via an XML packing process.

24. The method of claim 22 wherein the performing comprises:
scanning the XML representation for the at least one feature.

25. The method of claim 22 wherein the performing comprises:
editing a buffer storing the XML representation in place via an XML packing process.

26. The method of claim 23 wherein the XML packing process comprises at least one call to memmove.

27. The method of claim 25 wherein the XML packing process comprises at least one call to memmove.

28. The method of claim 21 wherein the XML representation of the XML data comprises a stored database representation of the XML data

29. The method of claim 21 further comprising modifying at least one feature of the XML data via a naive modification operating on the XML representation of the XML data.

30. The method of claim 29 wherein the XML representation of the XML data comprises a stored database representation of the XML data.

31. A method of manipulating XML data in support of data mining, wherein the XML data is stored in an XML representation of the XML data, the method comprising:
modifying at least one feature of the XML data via a naive modification operating on the XML representation of the XML data.

32. The method of claim 31 wherein the modifying comprises:
selecting the at least one feature via an in-place selection of the at least one feature;
removing the selected feature from the XML representation, thereby resulting in a modified XML representation; and
adding at least one new feature with a new value to the modified XML representation.

33. The method of claim 32 the adding comprises:
appending the at least one new feature to the modified XML representation.

34. The method of claim 33 wherein the appending comprises:
parsing backward from the end one close tag of the modified XML representation; and
inserting the at least one new feature to the modified XML representation before the end one close tag.

35. The method of claim 31 wherein the XML representation of the XML data comprises a stored database representation of the XML data.

36. The method of claim 31 further comprising selecting at least one feature in the XML data via a naive selection operating on the XML representation of the XML data.

37. The method of claim 36 wherein the XML representation of the XML data comprises a stored database representation of the XML data.

38. A method of manipulating XML data in support of data mining, the method comprising:
storing the XML data in a network format to a buffer, thereby resulting in a stored network representation of the XML data.

39. The method of claim 38 wherein the network format comprises xtalk format.

40. The method of claim 39 wherein the storing comprises:
writing the XML data in xtalk format to the buffer, thereby resulting in a stored xtalk representation of the XML data, wherein the xtalk representation comprises xtalk fragments corresponding to fragments of the XML data,
wherein one of the xtalk fragments comprises header information of the XML data and
wherein each of the remaining xtalk fragments corresponds uniquely with a feature of the XML data.

41. The method of claim 40 wherein the writing comprises:
saving each of the xtalk fragments to a corresponding block of the buffer.

42. The method of claim 41 wherein the saving comprises:
for each xtalk fragment corresponding to a feature of the XML data, reserving the string length of the feature in the corresponding block of the buffer of the xtalk fragment.

43. A method of manipulating XML data in support of data mining, the method comprising:
storing the XML data in a network format to a buffer, thereby resulting in a stored network representation of the XML data;
selecting at least one feature of the XML data via a naive selection operating on the stored network representation of the XML data; and
modifying at least one feature of the XML data via a naive modification operating on the stored network representation of the XML data.

44. The method of claim 43 wherein the network format comprises xtalk format.

45. A method of manipulating XML data in support of data mining, wherein the XML data is stored in an XML representation of the XML data, the method comprising:
selecting at least one feature in the XML data via a naive selection operating on the XML representation of the XML data; and
modifying at least one feature of the XML data via a naive modification operating on the XML representation of the XML data.

46. The method of claim 45 wherein the selecting comprises:
performing an in-place selection of the at least one feature.

47. The method of claim 45 wherein the modifying comprises:
choosing the at least one feature via an in-place selection of the at least one feature;
removing the selected feature from the XML representation, thereby resulting in a modified XML representation; and
adding at least one new feature with a new value to the modified XML representation.

48. The method of claim 11 wherein the modifying comprises:
dropping at least one feature of the XML data. data.

49. The method of claim 11 wherein the modifying comprises:
adding at least one feature of the XML data. data.

50. The method of claim 11 wherein the modifying comprises:
dropping at least one feature of the XML data; and
adding at least one feature of the XML data.

51. A system of manipulating XML data in support of data mining, the system comprising:
a storing module configured to store the XML data in a network format to a buffer, thereby resulting in a stored network representation of the XML data; and
a selecting module configured to select at least one feature of the XML data via a naive selection operating on the stored network representation of the XML data.

52. A computer program product usable with a programmable computer having readable program code embodied therein of manipulating XML data in support of data mining, the computer program product comprising:
computer readable code for storing the XML data in a network format to a buffer, thereby resulting in a stored network representation of the XML data; and
computer readable code for selecting at least one feature of the XML data via a naive selection operating on the stored network representation of the XML data.
